(19) United States
(12) Patent Application Publication
(10) Pub. No.: US 2019/0181474 A1
(43) Pub. Date: Jun. 13, 2019

(54) FUEL CELL APPARATUS

(71) Applicants: DAINICHI CO., LTD., Niigata city, Niigata (JP); KYOCERA CORPORATION, Kyoto-shi, Kyoto (JP)

(72) Inventors: Shintaro YANAGIUCHI, Niigata city, Niigata (JP); Tomohiro FUKAGAWA, Niigata city, Niigata (JP); Hiroki OGURO, Niigata city, Niigata (JP); Nao HAYAKAWA, Niigata city, Niigata (JP); Tatsuya KANBAYASHI, Niigata city, Niigata (JP)

(21) Appl. No.: 16/323,795

(22) PCT Filed: Aug. 9, 2017
(86) PCT No.: PCT/JP2017/028901

§ 371 Date: Feb. 7, 2019

(30) Foreign Application Priority Data
Aug. 10, 2016 (JP) 2016-158257
Mar. 31, 2017 (JP) 2017-072854

(51) Int. Cl. H01M 8/04701; H01M 8/04746; H01M 8/04007; H01M 8/04014

(52) U.S. Cl. CPC H01M 8/04701; H01M 8/04022; H01M 8/04067; H01M 8/04746

(57) ABSTRACT

A fuel cell apparatus may include a fuel cell module; a heat exchanger; a circulation line connected to the heat exchanger; a heat dissipator located in the circulation line; and an exterior case which houses the fuel cell module, the heat exchanger, the heat dissipator, and at least part of the circulation line. The heat dissipator may be provided with two openings, and includes at least a duct which defines an air flow channel between the two openings; a fan located on first opening side of the two openings in the air flow channel; and a radiator located on the second opening side of the two openings in the air flow channel. The exterior case may be provided with two ventilation holes to which the two openings are connected directly or via an air passageway, respectively, and the duct includes a plurality of separable parts.

### CROSS-REFERENCE TO RELATED APPLICATIONS

This application is a national stage entry according to 35 U.S.C. 371 of PCT Application No. PCT/JP2017/028901 filed on Aug. 9, 2017, which claims priority to Japanese Application Nos. 2016-158257 filed on Aug. 10, 2016, and 2017-072854 filed on Mar. 31, 2017, which are entirely incorporated herein by reference.

### TECHNICAL FIELD

The present disclosure relates to a fuel cell apparatus.

### BACKGROUND

In recent years, as next-generation energy sources, there have been proposed various fuel cell modules of the type that may include a cell stack, which is housed in a housing, may include a plurality of stacked fuel cells capable of obtaining electric power by utilizing a fuel gas (hydrogen-containing gas) and air (oxygen-containing gas), and also fuel cell apparatuses each of which may include such a fuel cell module housed in an exterior case.

There is another proposal as to a fuel cell apparatus, which may include a heat storage tank, in which a heat exchanger carries out heat exchange between exhaust gas from a fuel cell module and a medium, such as water, to cool the exhaust gas for recovery and reuse of water contained in the exhaust gas, and also the heat recovered by the medium may be utilized for the supply of hot water.

Moreover, there is discussion of a technique to supply a medium to a heat exchanger after lowering the temperature of the medium by a heat dissipator disposed between a heat-storage tank and the heat exchanger. For example, Japanese Unexamined Patent Publication JP-A 2009-38015 (Patent Literature 1) discusses a construction in which an exterior case may have an air inlet provided in one surface thereof and an air outlet provided in the opposite surface thereof, and, Japanese Unexamined Patent Publication JP-A 2015-72090 (Patent Literature 2) discusses a construction in which an exterior case may have an air inlet and an air outlet for a heat dissipator provided in one and the same surface thereof.

Furthermore, with regard to exhaust air flow control in a heat dissipator, for example, Japanese Unexamined Patent Publication JP-A 2010-92775 and Japanese Unexamined Patent Publication JP-A 2016-217670 (Patent Literatures 3 and 4) discuss a fuel cell apparatus that may have an air flow channel such as a duct.

### SUMMARY

A fuel cell apparatus according to a non-limiting aspect of the present disclosure may include: a fuel cell module; a heat exchanger which carries out heat exchange between exhaust gas from the fuel cell module and a medium; a circulation line connected to the heat exchanger, the circulation line allowing the medium to circulate through the heat exchanger; a heat dissipator located in the circulation line, the heat dissipator cooling the medium flowing through the heat exchanger; and an exterior case which houses the fuel cell module, the heat exchanger, the heat dissipator, and at least part of the circulation line.

The heat dissipator may be provided with two openings. The heat dissipator may include a duct which defines an air flow channel between the two openings; a fan located closer to a first opening of the two openings than a second opening of the two openings in the air flow channel, the fan producing flowing air; and a radiator located closer to the second opening than the first opening in the air flow channel, the radiator carrying out heat exchange between the medium and air flowing through an interior of the air flow channel.

The exterior case may be provided with two ventilation holes to which the two openings are connected directly or via an air passageway, respectively, and the duct may include a plurality of separable parts.

### BRIEF DESCRIPTION OF DRAWINGS

Other and further objects, features, and advantages of the invention will be more explicit from the following detailed description taken with reference to the drawings wherein:

FIG. 1 is a block diagram showing the structure of an example of a fuel cell apparatus according to a non-limiting aspect of the present disclosure;

FIG. 2 is a perspective view showing the appearance of an example of the fuel cell apparatus according to a non-limiting aspect of the present disclosure;

FIG. 3 is one side view of an example of the fuel cell apparatus according to a first non-limiting embodiment;

FIG. 4 is another side view of an example of the fuel cell apparatus according to the first non-limiting embodiment;

FIG. 5A is an exploded perspective view showing a specific example of a heat dissipator of the first non-limiting embodiment;

FIG. 5B is an exploded perspective view showing a specific example of the heat dissipator of the first non-limiting embodiment;

FIG. 6A is a view schematically showing the heat dissipator of the first non-limiting embodiment;

FIG. 6B is a view schematically showing the heat dissipator of the first non-limiting embodiment;

FIG. 7A is an explanatory view of a structural example of a radiator duct of the first non-limiting embodiment;

FIG. 7B is an explanatory view of a structural example of the radiator duct of the first non-limiting embodiment;

FIG. 8 is a side view of an example of a fuel cell apparatus according to a second non-limiting embodiment;

FIG. 9 is a side view of an example of the fuel cell apparatus according to the second non-limiting embodiment;

FIG. 10 is an explanatory view of a structural example of a heat dissipator of the fuel cell apparatus according to the second non-limiting embodiment;

FIG. 11 is an explanatory view of another structural example of the heat dissipator of the fuel cell apparatus according to the second non-limiting embodiment;

FIG. 12 is an explanatory view of another structural example of the heat dissipator of the fuel cell apparatus according to the second non-limiting embodiment;

FIG. 13 is an explanatory view of another structural example of the heat dissipator of the fuel cell apparatus according to the second non-limiting embodiment;

FIG. 14 is a schematic sectional view of the heat dissipator of the fuel cell apparatus shown in FIG. 13; and

FIG. 15 is a schematic sectional view of the heat dissipator of the fuel cell apparatus shown in FIG. 13.

### DETAILED DESCRIPTION

Disposing a heat dissipator in a lower part of a fuel cell apparatus causes complications in maintenance operation. Thus, ease of maintenance has been demanded in a heat dissipator which is located in a fuel cell apparatus. The following describes fuel cell apparatuses according to non-limiting embodiments of the disclosure in sequence.

### First Non-Limiting Embodiment

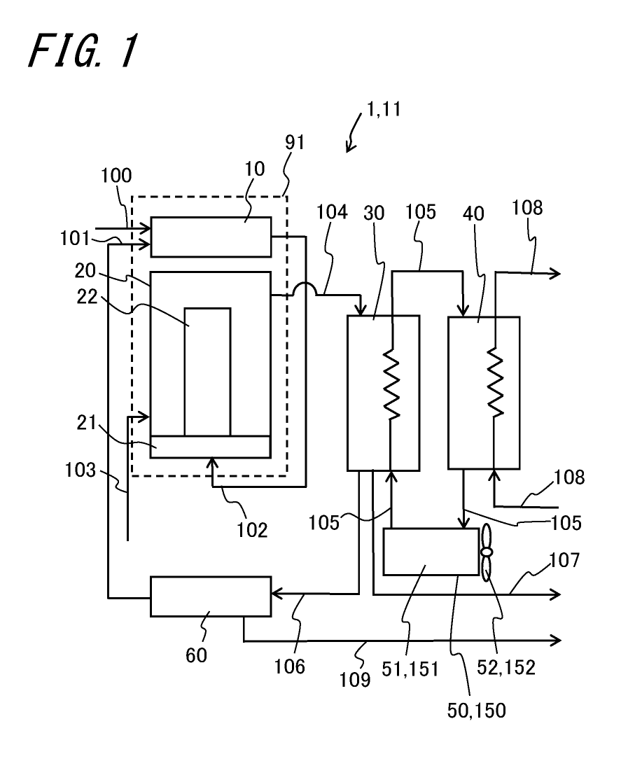

FIG. 1 is a block diagram showing the structure of an example of a fuel cell apparatus according to the present disclosure. Throughout the drawings to be hereafter referred to, the same reference numerals or symbols designate corresponding or identical constituent components. A fuel cell apparatus 1 according to the first non-limiting embodiment includes a reformer 10, a cell stack device 20, a heat exchanger 30, a heat-storage tank 40, a heat dissipator 50, and a condensed water tank 60. Each such constituent device is, together with auxiliary machines which operate a fuel cell module 91 as described later, housed in an exterior case, not shown. It is not necessary to house all of the aforenamed devices in the exterior case, and for example, the heat-storage tank 40 and the heat exchanger 30 may be disposed outside the exterior case. Moreover, the fuel cell apparatus in which apart of the aforenamed devices is omitted is also possible.

A raw fuel supply pipe 100 which supplies a raw fuel and a water supply pipe 101 which supplies reformed water are connected to the reformer 10. Inside the heated reformer 10, the raw fuel and the reformed water undergo reforming reactions with each other to produce a hydrogen-containing reformed gas. The reformed gas produced in the reformer 10 is supplied to the cell stack device 20 through a reformed gas supply pipe 102.

The cell stack device 20 includes a manifold 21 and a cell stack 22. the reformed gas supplied to the cell stack device 20 is supplied from the manifold 21 into the cell stack 22. In the cell stack device 20, air (oxygen-containing gas) is introduced from an oxygen-containing gas supply member 103 outside the cell stack 22. When passing through the interior of the cell stack 22, the reformed gas reacts with this air to carry out power generation. In a region above the cell stack 22, reformed gas left unused for power generation merges with air left unused for power generation, and the resulting confluent flow is burned to produce high-temperature exhaust gas. Moreover, the reformer 10 is heated under heat resulting from the combustion.

The reformer 10 and the cell stack device 20 are brought into high-temperature conditions, and are encased by a heat-insulating material and are placed inside the exterior case as the fuel cell module 91.

Exhaust gas generated in the fuel cell module 91 is discharged from the cell stack device 20, and is then supplied to the heat exchanger 30 through an exhaust gas flow channel 104. A circulation line 105 is connected to the heat exchanger 30 to carry out heat exchange between the exhaust gas and a medium introduced in the circulation line 105. As the medium, it is possible to use a non-freezing liquid containing ethylene glycol, etc., or water. Under the heat exchange, the exhaust gas is cooled, whereas the medium is heated by the heat of the exhaust gas. Due to the cooling of the exhaust gas, water vapor contained in the exhaust gas becomes water, with consequent occurrence of vapor-liquid separation. The separated gas is discharged through an exhaust channel 107 from a gas exhaust outlet externally. The water separated by the cooling of the exhaust gas is delivered through a condensed water recovery channel 106 to the condensed water tank 60. In the condensed water tank 60, the water is purified into pure water through an ion exchange process or otherwise. The pure water is introduced into the water supply pipe 101, and is then supplied, as reformed water, to the reformer 10. Unnecessary water is ejected from a drain 109.

The medium is circulated successively through the heat-storage tank 40, the heat dissipator 50, and the heat exchanger 30 in the order named. The medium is stored in the heat-storage tank 40. After being delivered from the heat-storage tank 4 to the heat dissipator 50, the medium is cooled, and then supplied to the heat exchanger 30. In the heat exchanger 30, the medium is heated by heat exchange with the exhaust gas. The medium having an elevated temperature is returned to the heat-storage tank 40.

That is, there is formed the circulation line 105 in which the medium is circulated successively through the heat-storage tank 40, the heat dissipator 50, and the heat exchanger 30 in the order named. In other words, the heat-storage tank 40, the heat dissipator 50, and the heat exchanger 30 are disposed successively in the order named along the circulation line 105.

A hot water supply piping is introduced in the heat-storage tank 40 to utilize heated water resulting from heat exchange between water delivered from a water supply pipe 108 and the medium stored in the heat-storage tank 40 as hot water. Where water is used as the medium, the fuel cell apparatus may be configured so as to supply the medium as hot water per se.

When the amount of heat accumulated in the heat-storage tank 40 reaches the upper limit (full heat storage state), the medium is no longer able to recover the heat of the exhaust gas in the heat exchanger 30, and consequently the exhaust gas cannot be cooled sufficiently, causing a failure in the separation of moisture from the exhaust gas. As a result, a failure in condensation of moisture contained in the exhaust gas may lead to a shortage of water which is supplied to the reformer 10. Accordingly, it is necessary to decrease the temperature of the medium which is supplied to the heat exchanger 30. In the fuel cell apparatus 1 according to the present non-limiting embodiment, the medium is cooled by the heat dissipator 50 and to then supplied to the heat exchanger 30. The heat dissipator 50 includes a radiator 51 and a fan 52. When the medium is at a high temperature, the fan 52 is actuated to facilitate dissipation of heat from the medium passing through the interior of the radiator 51. On the other hand, when the medium is at a low temperature, the fan 52 is left unactuated to restrain dissipation of heat from the medium in the heat dissipator 50.

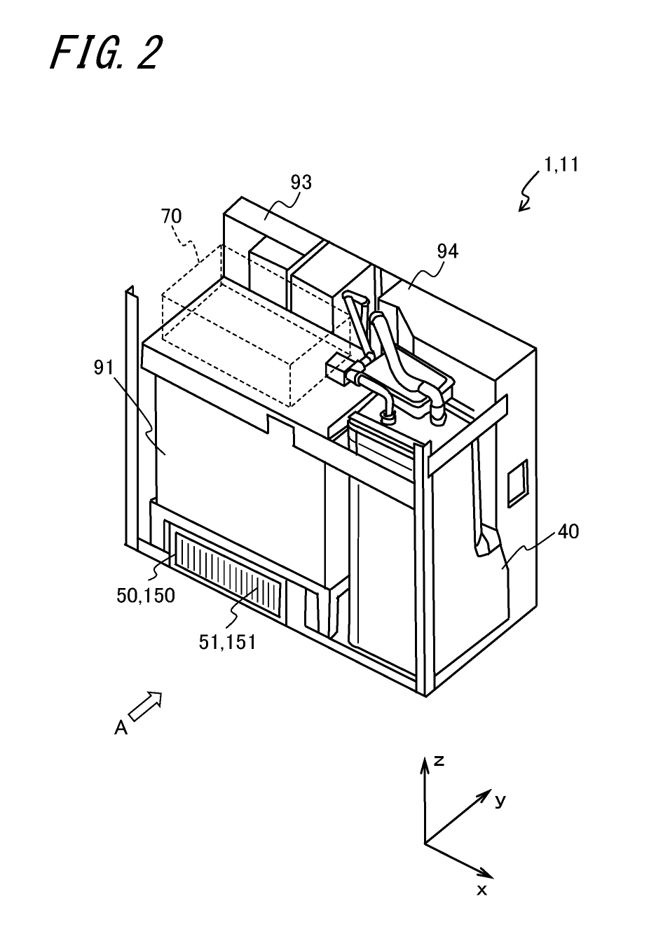

FIG. 2 is a perspective view showing the appearance of an example of the fuel cell apparatus according to the present disclosure. In FIG. 2, for purposes of explanation of the interior of the fuel cell apparatus, there is shown the fuel cell apparatus with the exterior case (more specifically, four side panels, a top panel, etc. constituting the outer frame of the fuel cell apparatus) removed. In the following description, the side panel will be also referred to simply as “side”. For purposes of convenience, a face of the fuel cell apparatus as viewed in the direction of arrow A (or equivalently a y direction) in FIG. 2 is defined as a front face of the fuel cell apparatus 50. Moreover, a rightward direction as viewed from the front face is defined as an x direction, and a height direction is defined as a z direction. In the fuel cell apparatus 1, the heat dissipator 50 is disposed below the fuel cell module 91, and, the heat-storage tank 40 is disposed on a lateral side of the fuel cell module 91 and the heat dissipator 50.

Moreover, a control board 93 for controlling the fuel cell apparatus 1 is disposed on a lateral side of the fuel cell module 91, and, a power conditioner 94 for supplying electric power produced by the fuel cell module 91 to outside is disposed on a lateral side of the heat-storage tank 40. In addition, an auxiliary machine 70 such as a fuel pump is disposed above the fuel cell module 91 to operate the fuel cell module 91. One or more auxiliary machines 70 are disposed inside a space indicated by a dotted line. The description of the specific configuration of the auxiliary machine will be omitted.

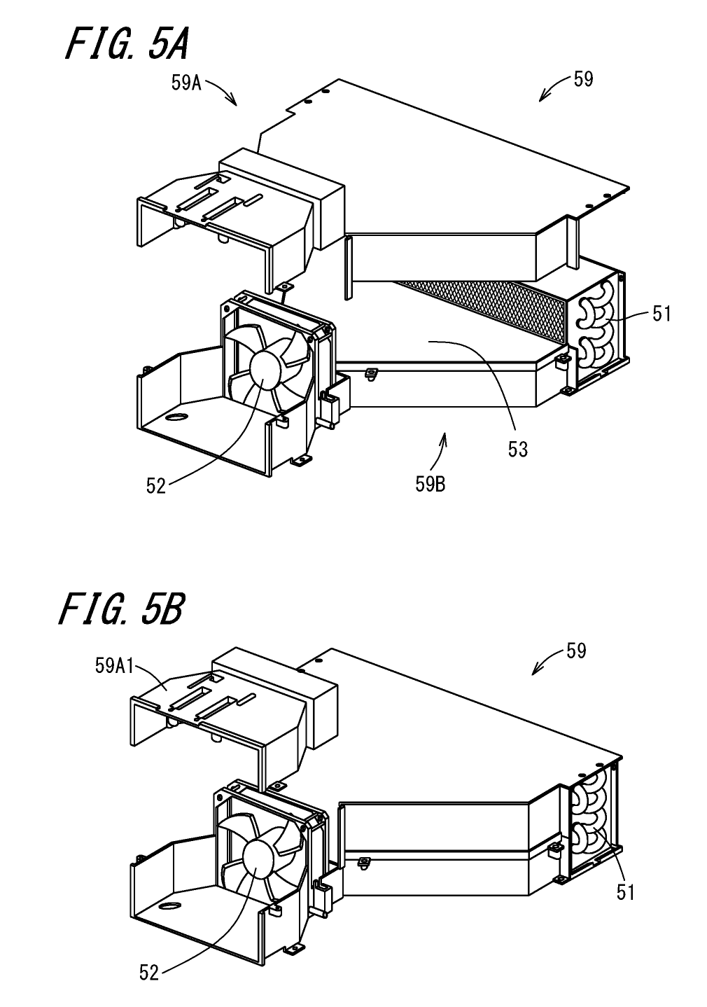

The heat dissipator 50 includes a narrow piping of the radiator 51 through which the medium passes (refer to FIGS. 5A and 5B). Disposing the heat dissipator 50 below the fuel cell module 91 enables protection of the fuel cell module 91 from trouble such as liquid leakage from the radiator. Moreover, disposing the heat dissipator 50 below the control board 93 and the power conditioner 94 enables protection of the control board 93 and the power conditioner 94 from trouble such as liquid leakage from the radiator. In addition, disposing the heat dissipator 50 below the fuel cell module 91 enables introduction of external air having a relatively low temperature, and thus can enhance the heat-dissipation efficiency.

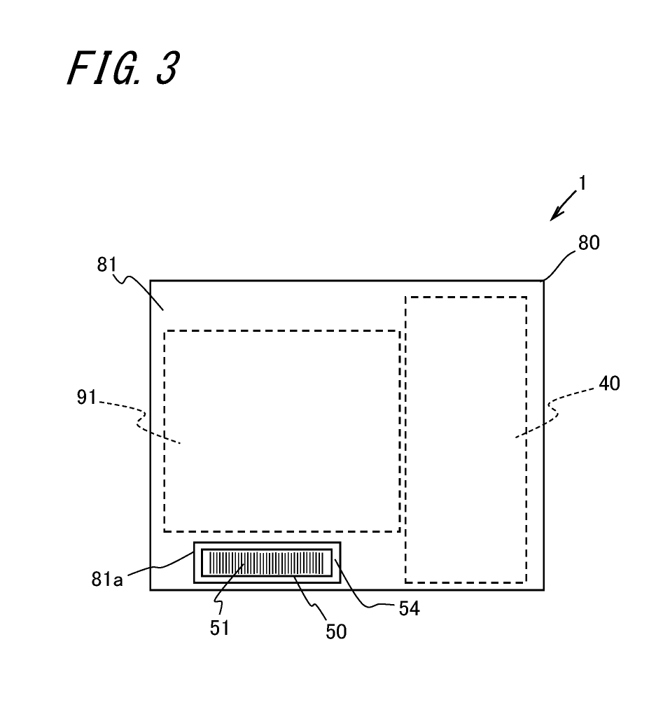

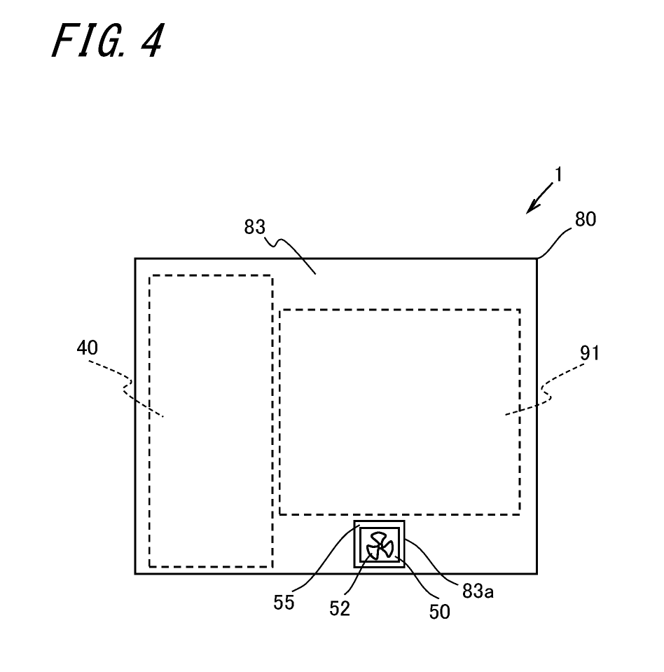

FIG. 3 is one side view of an example of the fuel cell apparatus according to the present non-limiting embodiment, illustrating a side face 81 of an exterior case 80 having longitudinal sides. FIG. 4 is the other side view of an example of the fuel cell apparatus according to the present non-limiting embodiment, illustrating a side face 83 of the exterior case 80 opposite to the side face 81. As shown in FIG. 3, the exterior case 80 for housing devices constituting the fuel cell apparatus 1 is shaped in a rectangular prism. In a lower side opening 81a of the side face 81 of the exterior case 80, an air inlet 54 and the radiator 51 of the heat dissipator 50 are disposed. On the other hand, as shown in FIG. 4, in a lower side opening 83a of the side face 83 of the exterior case 80, an air outlet 55 and the fan 52 of the heat dissipator 50 are disposed.

As shown in FIGS. 3 and 4, an opening area of the air inlet 54 is larger than an opening area of the air outlet 55. This makes it possible to increase the amount of air which is introduced from the air inlet 54, and thereby efficiently cool the medium flowing through the interior of the piping of the radiator 51. Moreover, forming the air inlet 54 in the large-area side face 81 allows the air inlet 54 to have a large opening area. In addition, an opening area of the opening 81a connected with the air inlet 54 can be larger than an opening area of the opening 83a connected with the air outlet 55.

As described above, the fuel cell module 91 indicated by a broken line is disposed above the heat dissipator 50 to avoid any trouble associated with the heat dissipator 50, as well as to achieve an improvement in heat-dissipation efficiency in the heat dissipator 50. The heat-storage tank 40 is disposed adjacent to the fuel cell module 91.

FIGS. 5A and 5B are each an exploded perspective view showing a specific example of the heat dissipator of the present non-limiting embodiment. The heat dissipator 50 includes the radiator 51, the fan 52, an air flow channel 53, and a radiator duct (hereafter also referred to simply as “duct”) 59. The duct 59, in the form of a frame body that defines the air flow channel 53, includes a plurality of separable parts. Thus, it is possible to achieve good maintainability. Moreover, for example, the duct 59 is made of resin and is thus lighter in weight than a metal-made duct. This facilitates duct servicing and maintenance.

The duct 59 shown in FIG. 5A includes an upper duct 59A and a lower duct 59B. In FIG. 5A, the upper duct 59A is illustrated as being separated from the lower duct 59B. By designing the duct 59 so that the upper duct 59A can be separated from the lower duct 59B, it is possible to achieve good maintainability.

FIG. 5B shows a case where the upper duct 59A includes a first duct 59A1 which is separable from the upper duct 59A. By designing the duct 59 so that the first duct 59A1 can be separated from the upper duct 59A, it is possible to achieve good maintainability for the fan 52, etc. located below the first duct 59A1.

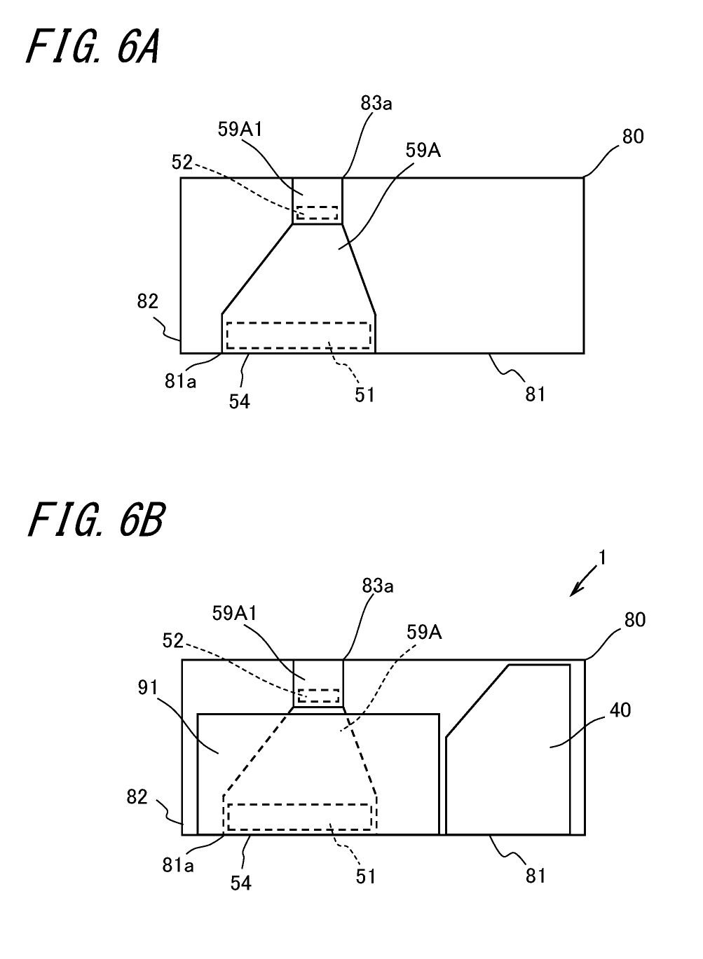

FIGS. 6A and 6B are each a view schematically showing the heat dissipator of the present non-limiting embodiment. FIG. 6A is an explanatory view of a structural example of the heat dissipator of the present non-limiting embodiment, illustrating the structure of the heat dissipator 50 disposed over the bottom face of the exterior case 80, as seen in a plan view.

Upon actuation of the fan 52 of the heat dissipator 50, air is introduced from the air inlet 54 connected to the opening 81a formed in the side face 81 under negative pressure, and, the medium flowing through the interior of the piping is cooled when the air passes through the radiator 51. After passing through the radiator 51, the air passes through the air flow channel 53 and the fan 52, and is eventually discharged from the air outlet 55 connected to the opening 83a formed in the side face 83.

The air flow channel 53, which is defined by the duct 59, may be communicated with other portions in the exterior case 80. In this case, by the operation of the fan 52, in addition to air present in the heat dissipator 50, air present in portions other than the heat dissipator 50 in the exterior case 80 can be discharged.

FIG. 6B is a plan view showing the positional relationship between the heat dissipator of the present non-limiting embodiment and other devices. As shown in FIG. 6B, in the heat dissipator 50 as seen in a transparent plan view, the first duct 59A1 lies outside the range of the fuel cell module 91. The first duct 59A1 constitutes part of the upper duct 59A. The first duct 59A1 is separable from the upper duct 59A, and it is thus possible to facilitate replacement of the fan 52 located below the first duct 59A1.

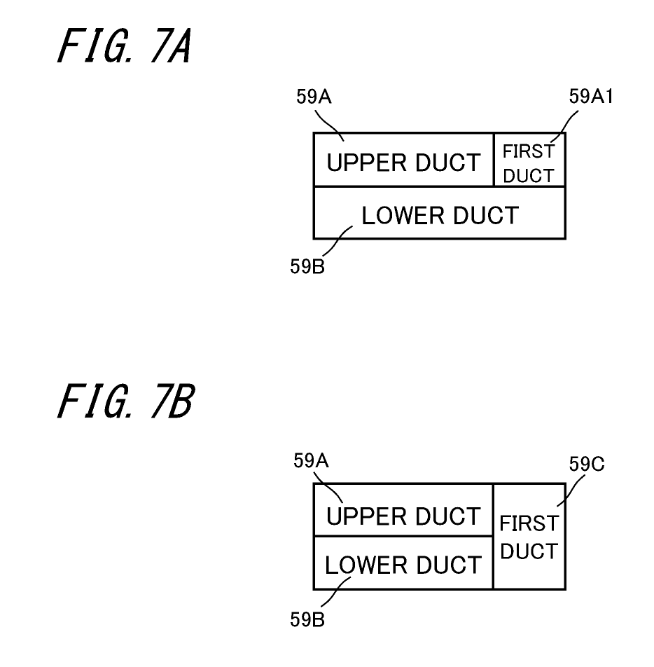

FIGS. 7A and 7B are each an explanatory view of a structural example of the radiator duct of the present non-limiting embodiment. FIG. 7A shows a case where part of the upper duct 59A is constituted by the first duct 59A1 as described above with reference to FIG. 6B. FIG. 7B shows another case where a first duct 59C is disposed independently of the upper duct 59A and the lower duct 59B. In this structure, during maintenance operation, the first duct 59C can be separated completely from the upper duct 59A and the lower duct 59B, and it is thus possible to achieve good maintainability.

### Second Non-Limiting Embodiment

The following describes a fuel cell apparatus 11 according to a second non-limiting embodiment. Each constituent device of the fuel cell apparatus 11 is designed basically as is shown in the block diagram of FIG. 1 and the perspective view of FIG. 2, and thus overlapping descriptions will be omitted.

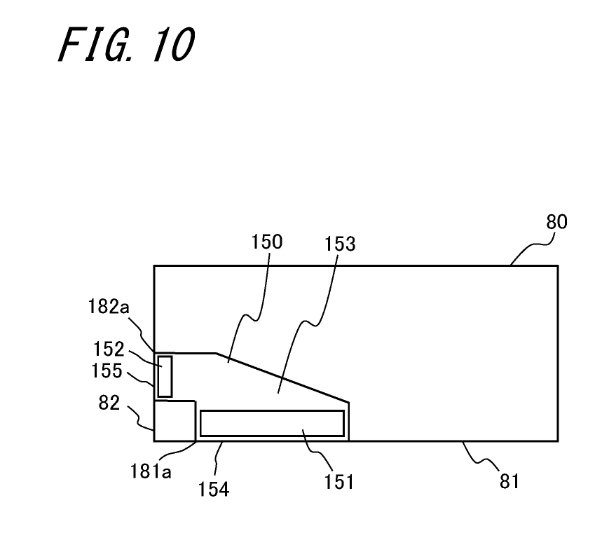

Moreover, the function of a heat dissipator 150 of the second non-limiting embodiment is identical with that of the heat dissipator 50 of the foregoing first non-limiting embodiment except for the shape of the air flow channel (refer to FIG. 10, for example). Thus, the detailed description of the heat dissipator 150 will be omitted.

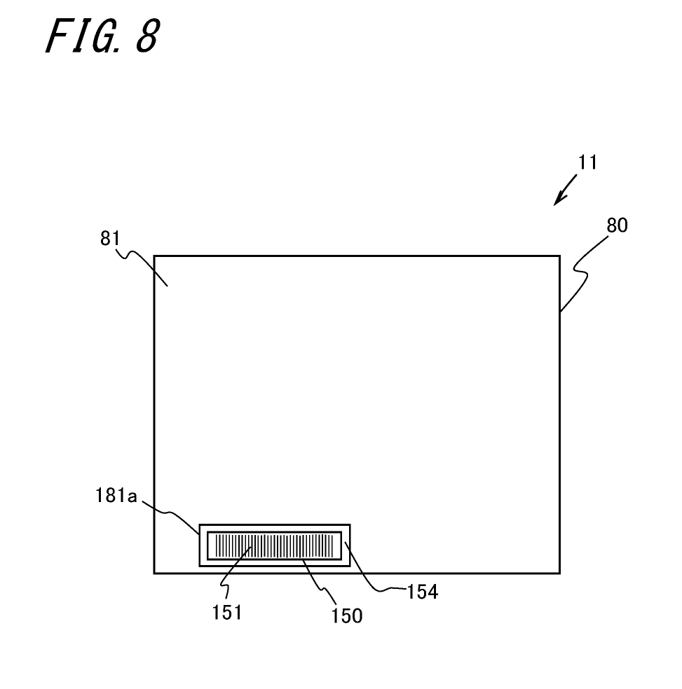

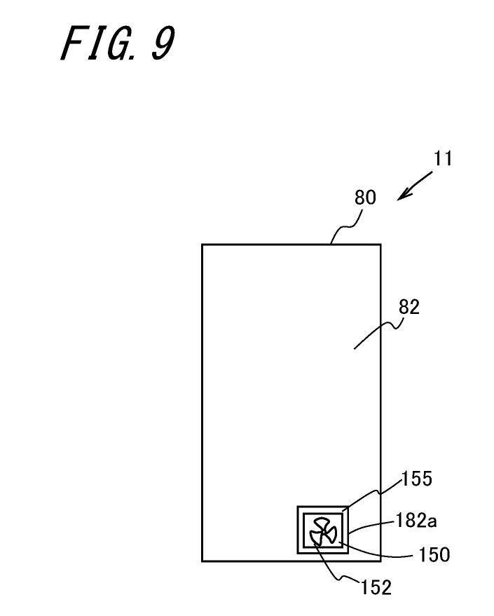

FIG. 8 is a side view of an example of the fuel cell apparatus according to the present non-limiting embodiment, illustrating a side face of an exterior case 80 having longitudinal sides. FIG. 9 is a side view of an example of the fuel cell apparatus according to this non-limiting embodiment, illustrating a side face of the exterior case 80 having transverse sides. The exterior case 80 for housing devices constituting the fuel cell apparatus 11 is also shaped in a rectangular prism. An area of the side face 81 of the exterior case 80 is larger than an area of the side face 82 of the exterior case 80 contiguous to the side face 81.

An air inlet 154 of the heat dissipator 150 is connected directly to an opening 181a formed in the large-area side face 81 so as to extend along the lower side of the side face 81, and, a radiator 151 is disposed in the air inlet 154.

An air outlet 155 of the heat dissipator 150 is connected directly to an opening 182a formed in the small-area side face 82 so as to extend along the lower side of the side face 82, and, a fan 152 is disposed in the air outlet 155.

The air inlet 154 and the air outlet 155 have been illustrated as being connected directly to the opening 181a and the opening 182a formed in the side face 81 and the side face 82, respectively. Also in cases where the air inlet 154 and the air outlet 155 are connected to their respective openings via air flow channels as described later, in the present non-limiting embodiment, the air inlet 154 makes connection with the opening 181a formed in the side face 81, and the air outlet 155 makes connection with the opening 182a formed in the side face 82.

The relationship in opening area between the air inlet 154 and the air outlet 155 is similar to the earlier described relationship in opening area between the air inlet 54 and the air outlet 55, and will thus not be described hereinbelow.

In setting such a rectangular prism-shaped fuel cell apparatus, especially in a residential house, in most cases, the fuel cell apparatus is oriented so that the large-area side face 81 is located substantially parallel to a house wall. With the side face 81 located substantially parallel to the house wall, the contiguous side face 82 faces into open space correspondingly, thus enabling safe and effective exhaust from the air outlet 55 provided in the side face 82. Moreover, owing to the side face 82 facing into open space, maintainability can be improved.

FIG. 10 is an explanatory view of a structural example of the heat dissipator of the fuel cell apparatus according to the present non-limiting embodiment, illustrating the structure of the heat dissipator 150 disposed over the bottom face of the exterior case 80, as seen in a plan view. The heat dissipator 150 includes the radiator 151, the fan 152, and an air flow channel 153.

The operation of the fan 152 is identical with that of the earlier described fan 52 except that air that has passed through the radiator 151 passes through the fan 152 along the air flow channel 153 with a 90° turn. Thus, the description of the fan 152 will be omitted.

While the air flow channel 153 is defined by, in addition to a partition wall plate, for example, the outer wall of a constituent device disposed around the heat dissipator, these wall portions are not intended to isolate the air flow channel 153 completely from other portions than the heat dissipator. Thus, the air flow channel 153 may be communicated with other portions in the exterior case 80. In this case, by the operation of the fan 152, in addition to air present in the heat dissipator 150, air present in portions other than the heat dissipator 150 in the exterior case 80 can be discharged. Where the air flow channel 153 is provided separately from other portions in the exterior case 80 for the purpose of cooling auxiliary machines, etc. mounted in the exterior case 80, an additional fan may need to be provided to ventilate the interior of the exterior case 80. In this regard, in the present non-limiting embodiment, discharge of air from both of the heat dissipator 150 and other portions in the exterior case 80, as well as replenishment of fresh air into both of them, can be carried out by a single fan 152. This eliminates the need to provide such an additional fan as above described, and thus reduces the number of fans in the fuel cell apparatus, with consequent downsizing of the fuel cell apparatus.

That is, as shown in FIG. 10, in the heat dissipator 150 of the present non-limiting embodiment, the air inlet 154 is provided so as to make connection with the opening 181a provided in the side face 81 which is one side face of the exterior case 80. Moreover, the air outlet 155 is provided so as to make connection with the opening 182a provided in the side face 82 which is the other face of the exterior case 80 contiguous to the side face 81. This arrangement reduces the size of the heat dissipator 150, and thus makes it possible to downsize the fuel cell apparatus.

Moreover, as shown in FIG. 10, the air inlet 154 is provided so as to make connection with the opening 181a provided in the side face 81 of the exterior case 80, and, the air outlet 155 is provided so as to make connection with the opening 182a provided in the side face 82 contiguous to the side face 81. In this case, even when the air inlet 154 faces windward, the air flow channel 153 bent in an L- or V-form constitutes resistance, and consequently external air is restrained from flowing to the interior through the air inlet 154. Consequently, since the medium flowing through the radiator 151 is not overcooled, it is possible to reduce deterioration in heat-storage performance in the heat-storage tank 40.

If the air inlet and the air outlet are provided so as to make connection with their respective openings provided in one common side face of the exterior case and to be located close to each other, for example, discharged air may flow into the air inlet once again, causing the efficiency of the heat dissipator to fall off. In this regard, by providing the air inlet 154 and the air outlet 155 so as to make connection with the opening 181a and the opening 182a, respectively, provided in different side faces contiguous to each other, the location for air introduction and the location for air discharge are separated from each other, and therefore it is possible to prevent a decrease in the cooling efficiency of the heat dissipator.

Moreover, an opening area of the air inlet 154 may be larger than an opening area of the air outlet 155. In addition, an opening area of the opening 181a connected with the air inlet 154 may be larger than an opening area of the opening 182a connected with the air outlet 155. This makes it possible to ensure the heat-dissipation capability of the radiator 151 located near the air inlet 154, and to reduce the size of the fan 152 located near the air outlet 155.

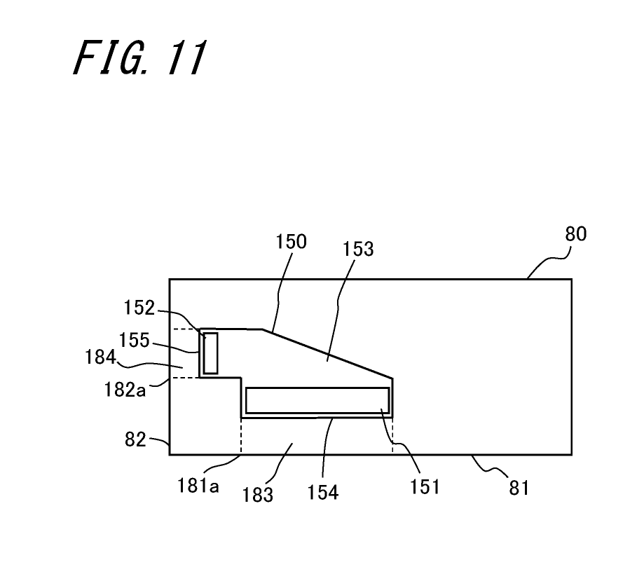

FIG. 11 is an explanatory view of another structural example of the heat dissipator of the fuel cell apparatus according to the present non-limiting embodiment. Where the heat dissipator 150 is disposed on an inward side of the fuel cell apparatus, the air inlet 154 is connected, through an air passageway 183, to the opening 181a provided in the side face 81, and, the air outlet 155 is connected, through an air passageway 184, to the opening 182a provided in the side face 82. This arrangement affords the same advantageous effects as achieved by the arrangement shown in FIG. 10.

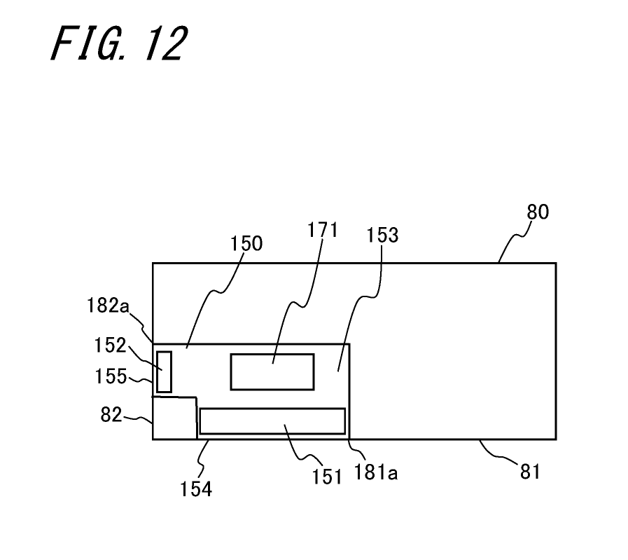

FIG. 12 is an explanatory view of still another structural example of the heat dissipator of the fuel cell apparatus according to the present non-limiting embodiment. As a point of difference from the arrangement shown in FIG. 10, an auxiliary machine 171 is disposed in the air flow channel 153 of the heat dissipator 150. Some of a plurality of auxiliary machines housed in the exterior case 80 include devices which get hot easily and thus exhibit high reliability when cooled, such as pumps. At least part of the plurality of auxiliary machines is disposed in the air flow channel 153 connecting the air inlet 154 and the air outlet 155. Thereby, it is possible to cool the mounted auxiliary machine 171 render the auxiliary machine highly reliable, and enhance the reliability of the fuel cell apparatus.

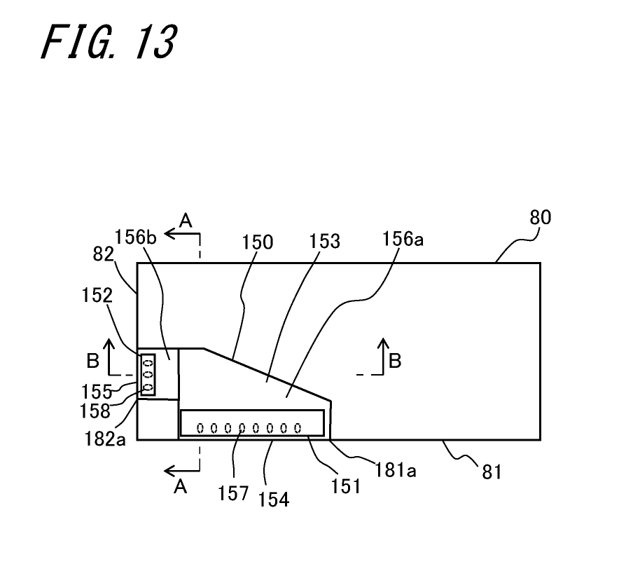

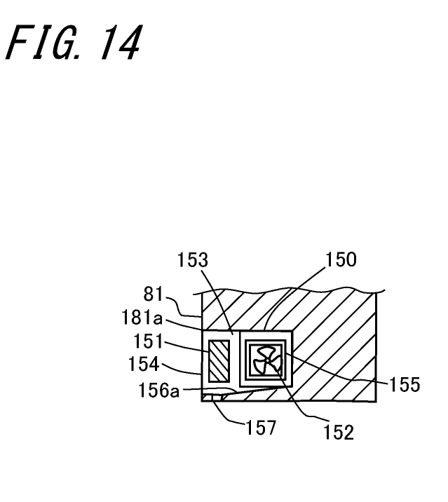

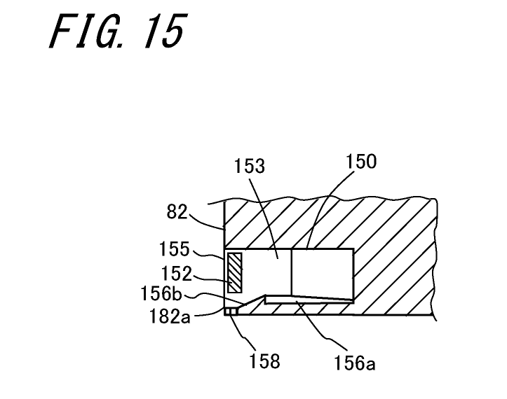

FIG. 13 is an explanatory view of yet another structural example of the heat dissipator of the fuel cell apparatus according to the present non-limiting embodiment. FIG. 14 is a schematic sectional view of the heat dissipator of the fuel cell apparatus shown in FIG. 13 taken along the section line A-A of FIG. 13. Moreover, FIG. 15 is a schematic sectional view of the heat dissipator of the fuel cell apparatus shown in FIG. 13 taken along the section line B-B of FIG. 13. The present non-limiting embodiment differs from the above-described fuel cell apparatus 10 shown in FIG. 10 in respect of the shape of the bottom face of the heat dissipator. In FIGS. 14 and 15, the cross-hatched area located outside the air flow channel 153 indicates a space where the fuel cell module 91, the auxiliary machine 70, etc. are disposed. The wall face of the air flow channel 153 is defined by a partition plate such as a metallic plate or part of the enclosures of devices mounted around the heat dissipator 150.

The air inlet 154 is provided so as to make connection with the opening 181a provided in the side face 81 of the exterior case 80, and, the air outlet 155 is provided so as to make connection with the opening 182a provided in the side face 82 contiguous to the side face 81. The air flow channel 153 connecting the air inlet 154 and the air outlet 155 is bent in an L-form in the exterior case 80. The bottom face of the air flow channel 153 defined by a metal-made partition plate, etc. includes a bottom face 156a opposed to the air inlet 154 and a bottom face 156b opposed to the air outlet 155.

Above the bottom face 156a opposed to the opening 181a (hereafter also referred to as the air inlet 154 in the following non-limiting embodiment), the radiator 151 is disposed. The bottom face 156a slopes downwardly from an inward side of the air flow channel 153, for example, the bend of the L-shaped air flow channel 53, toward the air inlet 154. Moreover, above the bottom face 156b opposed to the opening 182a (hereafter also referred to as the air outlet 155 in the following non-limiting embodiment), the fan 152 is disposed. The bottom face 156b slopes downwardly from an inward side of the air flow channel 153, for example, the bend of the L-shaped air flow channel 153, toward the air outlet 155.

In forming the bottom faces sloping downwardly toward the openings 181a and 182a, respectively, it is sufficient that each bottom face be free from any upward incline on its way to the opening. That is, for example, the bottom face may be configured to have a continuous slope, to have a slope which is partly made flat, or to have a stepped slope. Note that, where a drain hole is provided as described later, the bottom face may be configured to slope downwardly only to the location corresponding to the drain hole.

Assuming the entry of water such as rain water from the air inlet 154, since the bottom face 156a slopes downwardly toward the air inlet 154, the water present on the bottom face 156a flows toward the air inlet 154. This makes it possible to suppress the retention of water in the heat dissipator 150. Moreover, assuming the entry of water such as rain water from the air outlet 155, since the bottom face 156b slopes downwardly toward the air outlet 155, the water present on the bottom face 156b flows toward the air outlet 155. This makes it possible to suppress the retention of water in the heat dissipator 150.

The bottom face 156a may be provided with a drain hole 157 located below the radiator 151 and near the air inlet 154. Moreover, the bottom face 156b may be provided with a drain hole 158 located below the fan 152 and near the air outlet 155. The shape and number of the drain holes 157 and 158 are determined in conformance with the shapes of the air inlet 54 and the air outlet 155. Although the drain hole 157 is located near the air inlet 154, whereas the drain hole 158 is located near the air outlet 155 in the present non-limiting embodiment, the drain hole 157 may be located in any position of the bottom face 156a, and the drain hole 158 may also be located in any position of the bottom face 156b.

As the advantages of formation of the drain holes 157 and 158, considering the entry of water such as rain water from the air inlet 154, the water present on the bottom face 156a can be discharged from the drain hole 157 located near the air inlet 154, and also, considering the entry of water such as rain water from the air outlet 155, the water present on the bottom face 156b can be discharged from the drain hole 158 located near the air outlet 155.

Only when the drain holes 157 and 158 are provided, the bottom face may slope downwardly from the inward side of the air flow channel 153 toward each of the drain holes 157 and 158, as well as slope downwardly from each of the air inlet 154 and the air outlet 155 to each of the drain holes 157 and 158. In this case, the water entered can be collected in each of the drain holes 157 and 158 and flow therefrom.

Thus, by providing the drain holes 157 and 158, it is possible to discharge water which has entered through the air inlet 154 or the air outlet 155 without causing the water to flow over the surface of the exterior case 80. Moreover, since the drain holes 157 and 158 are provided inside the exterior case 80 (in other words, provided in the heat dissipator 150 or the air passageways 183 and 184), even under a substantial external wind pressure, the water entered can be discharged smoothly without being influenced by the wind pressure.

In the present non-limiting embodiment, there may be a case where the heat dissipator 150 is disposed in other location than the lowermost part of the exterior case 80. In such a case, a water supply pipe may be connected to the drain holes 157 and 158 to direct discharged water toward the bottom of the fuel cell apparatus 11 or away from the fuel cell apparatus 11. Moreover, there may be a case where the air inlet 154 is connected, through the air passageway 183, to the opening 181a provided in the side face 81, or the air outlet 155 is connected, through the air passageway 184, to the opening 182a provided in the side face 82. In this case, the air passageway 183 may be configured to slope downwardly toward the opening 181a, or the air passageway 184 may be configured to slope downwardly toward the opening 182a. Besides, the air passageways 183 and 184 may be provided with a drain hole.

Thus, since water which has entered the heat dissipator 150 flows toward the air inlet 154 or the air outlet 155, this avoids the retention of water in the heat dissipator 150, and thus protects the heat dissipator 150 from corrosion. Moreover, since the water which has entered can be discharged from the drain holes 157 and 158, this protects the heat dissipator 150 from corrosion. In consequence, a highly durable fuel cell apparatus is provided.

The present disclosure has been described in detail, it being understood that the present disclosure is not limited to the non-limiting embodiments as described heretofore, and various changes, modifications, and improvements are possible without departing from the scope of the present disclosure.

### REFERENCE SIGNS LIST

1, 11: Fuel cell apparatus
10: Reformer
20: Cell stack
30: Heat exchanger
40: Heat-storage tank
50, 150: Heat dissipator
51, 151: Radiator
52, 152: Fan
53, 153: Air flow channel
54, 154: Air inlet
55, 155: Air outlet
156a, 156b: Bottom face
157, 158: Drain hole
59: Radiator duct
59A: Upper duct
59B: Lower duct
59A1, 59C: First duct
60: Condensed water tank
70, 71: Auxiliary machine
80, 180: Exterior case
81, 82, 83: Side face
81a, 83a, 181a, 182a: Opening
83, 84, 183, 184: Air flow channel
91: Fuel cell module
105: Circulation line

1. A fuel cell apparatus, comprising:
a fuel cell module;
a heat exchanger which carries out heat exchange between exhaust gas from the fuel cell module and a medium;
a circulation line connected to the heat exchanger, the circulation line allowing the medium to circulate through the heat exchanger;
a heat dissipator located in the circulation line, the heat dissipator cooling the medium flowing through the heat exchanger, the heat dissipator provided with two openings,
the heat dissipator comprising:
a duct which defines an air flow channel between the two openings, the duct comprising a plurality of separable parts;
a fan located closer to a first opening of the two openings than a second opening of the two openings in the air flow channel, the fan producing flowing air; and
a radiator located closer to the second opening than the first opening in the air flow channel, the radiator carrying out heat exchange between the medium and air flowing through an interior of the air flow channel; and
an exterior case which houses the fuel cell module, the heat exchanger, the heat dissipator, and at least part of the circulation line, the exterior case provided with two ventilation holes to which the two openings are connected directly or via an air passageway, respectively.

2. The fuel cell apparatus according to claim 1, wherein
the heat dissipator is located below the fuel cell module.

3. The fuel cell apparatus according to claim 1, wherein
the plurality of separable parts of the duct include at least a first duct located close to the one opening.

4. The fuel cell apparatus according to claim 3, wherein
the plurality of separable parts of the duct further comprise an upper duct and a lower duct which are vertically separable from each other.

5. The fuel cell apparatus according to claim 3, wherein
at least the first duct lies outside a range of the fuel cell module, as seen in a transparent plan view of the fuel cell apparatus.

6. The fuel cell apparatus according to claim 1, wherein
the duct is made of resin.

7. The fuel cell apparatus according to claim 1, wherein
the fan operates to discharge, in addition to air introduced from one of the two ventilation holes, air present in portions other than the heat dissipator in the exterior case.

8. The fuel cell apparatus according to claim 1, wherein
a bottom face of the heat dissipator or a bottom face of the air passageway slopes downwardly toward the first opening or the second opening.

9. The fuel cell apparatus according to claim 1, wherein
a bottom face of the heat dissipator or a bottom face of the air passageway is provided with a drain hole.

10. The fuel cell apparatus according to claim 1, wherein
the duct is provided with an air outlet located close to the first opening, and an air inlet located close to the second opening, and
an opening area of the air inlet is greater than an opening area of the air outlet.

11. The fuel cell apparatus according to claim 1, wherein
the ventilation hole connected to the first opening is disposed in one side face of the exterior case, and
the ventilation hole connected to the second opening is disposed in another side face of the exterior case contiguous to the one side face.

12. The fuel cell apparatus according to claim 1, further comprising:
a plurality of auxiliary machines which operate the fuel cell module,
wherein at least part of the plurality of auxiliary machines is disposed in the air flow channel.
